(19) United States
(12) Patent Application Publication
(10) Pub. No.: US 2012/0305735 A1
(43) Pub. Date: Dec. 6, 2012

(54) MOBILE DEVICE STAND WITH ADHESIVE ATTACHMENT

(75) Inventor: Christopher Michael McSweyn, Oxnard, CA (US)

(73) Assignee: SCOSCHE INDUSTRIES, INC., Oxnard, CA (US)

(21) Appl. No.: 13/347,283

(22) Filed: Jan. 10, 2012

Related U.S. Application Data
(60) Provisional application No. 61/492,760, filed on Jun. 2, 2011.

(51) Int. Cl. F16M 11/04; B32B 37/12; B32B 37/14; A47B 97/08

(52) U.S. Cl. 248/451; 156/60; 156/66

(57) ABSTRACT

A device stand for mobile devices is disclosed herein. The device stand includes a planar body having a first side and a second side, wherein the first side includes a hinge; and a stand coupled to the hinge to pivot around the hinge. The second side includes a surface configured to conform to a mobile device, and an adhesive layer coupled to the second side of the planar body.

### CROSS-REFERENCE TO RELATED APPLICATION

This application claims priority from U.S. Provisional Application Ser. No. 61/492,760, filed Jun. 2, 2011, the contents of which are hereby incorporated by reference herein in their entirety.

### BACKGROUND

1. Field

The present disclosure relates to electronic device covers, and, more particularly, to a mobile device stand with adhesive attachment.

2. Description of Related Art

Housings, also known as cases, are used for any variety and number of purposes to protect electronic devices such as cameras, camcorders and other products from exposure to weather and other elements. Housings are also used to hold products such as flashlights, cell phones, global positioning systems (GPS), personal digital assistants (PDA's) portable radios and other similar handheld devices (herein collectively “electronic device”). Certain housings also have the additional feature of providing a belt strap or other interconnection mechanism to attach the housing to a user's belt or clothing. This feature prevents the housing and associated electronic device from being inadvertently lost or stolen, yet allowing a user to have their hands free for other uses. Still other housings provide a flat surface on the back to keep the housing low in profile. The housing and enclosed electronic device cannot be supported in a stable upright position on a flat surface such as a desk top. Thus, other types of housing provide a backing with a stand that allows the enclosed electronic device to be held in an upright position.

Many housings with stands are bulky, as well as require specialized attachment mechanisms that are customized to each model of phone. Further, many of these housings, even if they are customized to a particular model of phone, add bulk that prevent their use with most docks or charging stations.

It would be desirable to address one or more of the issues discussed above.

### SUMMARY

To address the various issues described herein, it is one aspect of the present invention to provide a device stand, the device stand having a planar body including a first side and a second side, wherein the first side includes a hinge; and a stand coupled to the hinge to pivot around the hinge; wherein the second side comprises a surface configured to conform to a mobile device. The device stand further includes an adhesive layer coupled to the second side of the planar body.

In another aspect of the present invention, a method for making a device stand is described herein. The method includes providing a planar body having a first side and a second side, wherein the first side includes a hinge; and a stand coupled to the hinge to pivot around the hinge; wherein the second side comprises a surface configured to conform to a mobile device; and attaching an adhesive layer to the second side of the planar body.

In another aspect of the present invention, a device stand includes a planar body having a first side and a second side, wherein the first side includes a hinge; and a support means coupled to the hinge to pivot around the hinge, wherein the second side includes a surface configured to conform to a mobile device. The device stand further includes an adhesive means coupled to the second side of the planar body.

It is understood that other aspects of the mobile device housing will become readily apparent to those skilled in the art from the following detailed description, wherein it is shown and described only exemplary configurations of a mobile device housing. As will be realized, the disclosure includes other and different aspects of mobile device housings and the various details presented throughout this disclosure are capable of modification in various other respects, all without departing from the spirit and scope of the novel and unobvious aspects of the invention. Accordingly, the drawings and the detailed description are to be regarded as illustrative in nature and not as restrictive.

### BRIEF DESCRIPTION OF THE DRAWINGS

FIG. 1 is a front elevational view of a mobile device stand with adhesive attachment configured in accordance with one aspect of the invention;

FIG. 2 is a rear elevational view of mobile device stand of FIG. 1, illustrating first attachment mechanism for a mobile device;

FIG. 3 is a front perspective view of the mobile device stand of FIG. 1;

FIG. 4 is a rear perspective view of the mobile device stand of FIG. 1;

FIG. 5 is a rear perspective view of a second attachment mechanism for the mobile device stand;

FIG. 6 is a rear perspective view of a mobile device being attached to the mobile device stand of FIG. 1;

FIG. 7 is a rear perspective view of the mobile device after being attached to the mobile device stand of FIG. 1; and

FIG. 8 is a front perspective view of a mobile device being attached to the mobile device stand of FIG. 1.

### DETAILED DESCRIPTION

The disclosed housing is described more fully hereinafter with reference to the accompanying drawings, in which various aspects of a mobile device stand with adhesive attachment are shown. The disclosed stand, however, may be embodied in many different forms and should not be construed as limited by the various aspects of the mobile device stand presented herein. The detailed description of the mobile device stand is provided below so that this disclosure will be thorough and complete, and will fully convey the scope of the present disclosure to those skilled in the art.

The detailed description may include specific details for illustrating various aspects of a mobile device stand with adhesive attachment. However, it will be apparent to those skilled in the art that the various aspects of the disclosure may be practiced without these specific details. In some instances, well known elements may be omitted to avoid obscuring the novel and unobvious concepts presented throughout this disclosure. Further, although the various embodiments may be described in terms of use with a mobile device such as a cellular phone, the described mobile device stand may be used for a variety of devices, including cameras, flashlights, global positioning systems (GPS), personal digital assistants (PDA's), multimedia players, portable radios and other similar handheld devices.

Various aspects of a mobile device stand may be illustrated by describing components that are coupled together. As used herein, the term “coupled” is used to indicate either a direct connection between two components or, where appropriate, an indirect connection to one another through intervening or intermediate components. In contrast, when a component referred to as being “directly coupled” to another component, there are no intervening elements present. Further, various aspects of the mobile device stand may be illustrated with reference to one or more exemplary embodiments. As used herein, the term “exemplary” means “serving as an example, instance, or illustration,” and should not necessarily be construed as preferred or advantageous over other aspects of the mobile device stand disclosed herein.

Relative terms such as “lower” or “bottom” and “upper” or “top” may be used herein to describe one element's relationship to another element illustrated in the drawings. It will be understood that relative terms are intended to encompass different orientations of a mobile device stand with adhesive attachment in addition to the orientation depicted in the drawings. By way of example, if the mobile device stand in the drawings is turned over, elements described as being on the “bottom” side of the other elements would then be oriented on the “top” side of the other elements. The term “bottom” can therefore encompass both an orientation of “bottom” and “top” depending on the particular orientation of the apparatus.

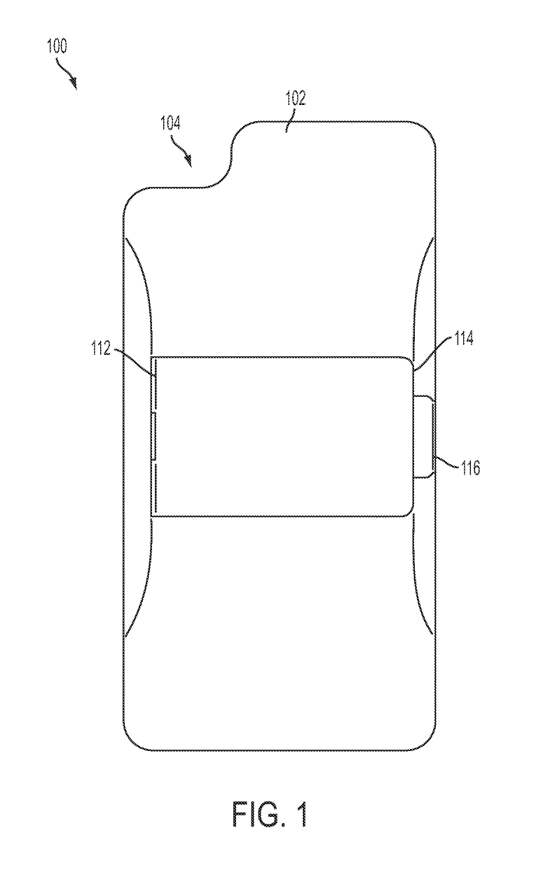

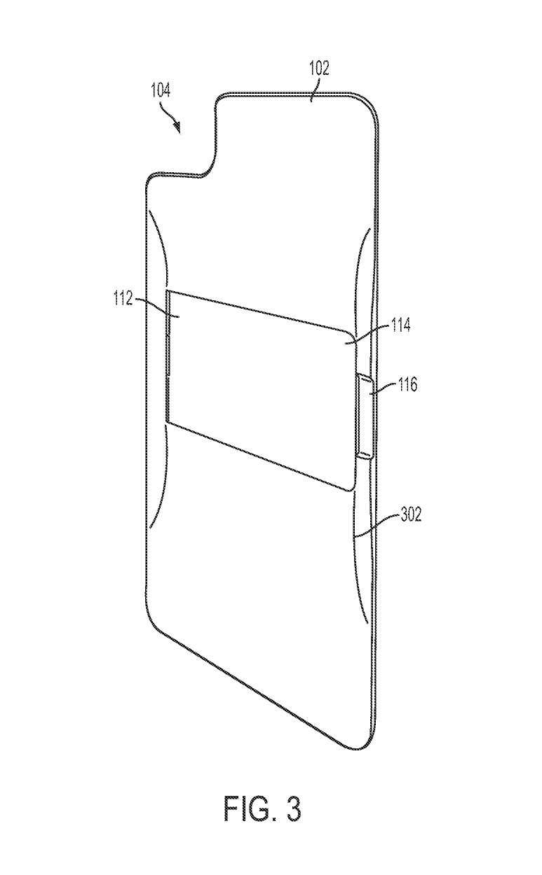

FIG. 1 illustrates a mobile device stand 100 configured in accordance with one aspect of the invention, with a stand 114 being coupled to a front surface 102 of the mobile device stand 100 via a hinge 112. The stand 114 may be deployed by a user lifting the stand 114 at a notched portion 116 on the front surface 102. The mobile device stand 100 also includes a notched portion 104 as an optional feature to allow access to certain parts of a mobile device, as further described herein. Also referring to FIG. 3, the mobile device stand 100 includes a raised portion 302 that allows the stand 114 to sit flushed against the front surface 102.

The mobile device stand 100 may be constructed out of plastics, metals, alloys or other relatively rigid material. In one aspect, the mobile device stand 100 may be formed from moldings. In another aspect, the mobile device stand 100 may be formed from stampings. A combination of materials may also be used and no limitation should be read into the present disclosure.

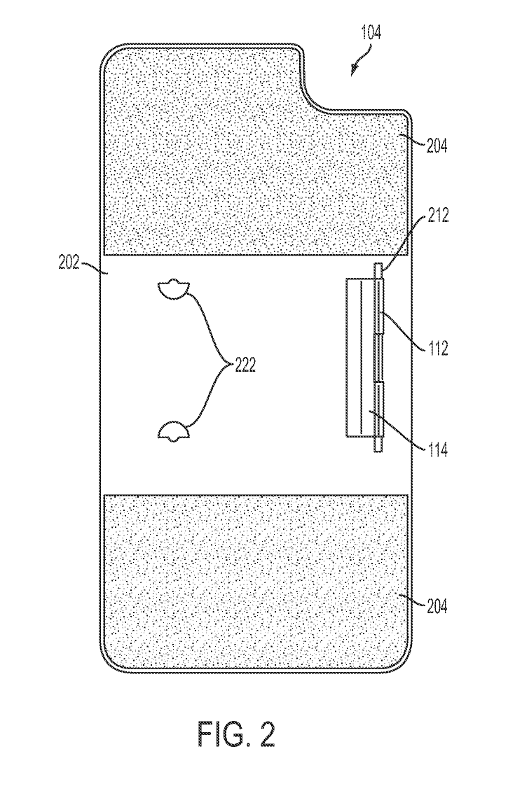

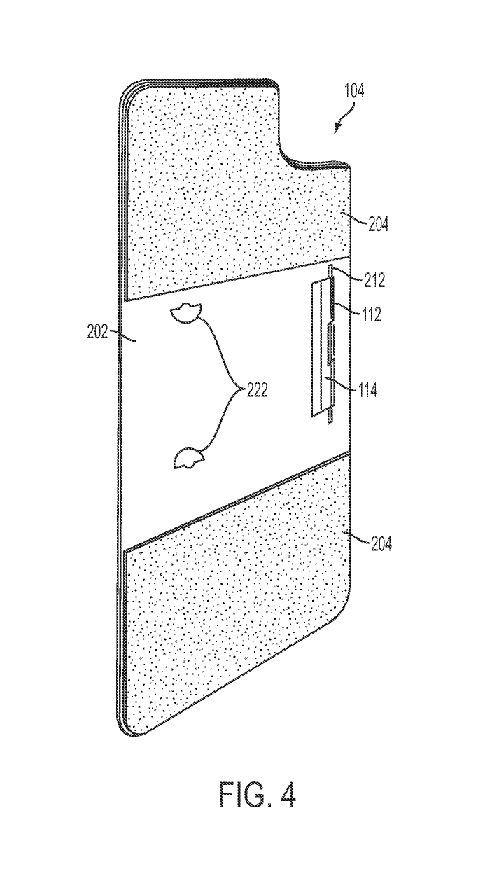

Referring now to FIG. 2, the mobile device stand 100 includes a rear surface 202 having an attachment mechanism. The rear surface 202 may include a plurality of openings 222. The rear surface 202 illustrates the hinge 112 having a pin 212 that attaches the stand 114 to the mobile device stand 100. Thus, the pin 212 of the hinge 122 allows the stand 114 to pivot and deployed as a stand to prop up the mobile device. In one aspect of the invention, the attachment mechanism includes a plurality of adhesives 204. The plurality of adhesives 204 allows the mobile device stand 100 to be attached to a mobile device in a relatively secure manner while not adding significant bulk or weight to the mobile device. For example, the mobile device stand 100 does not have to include attachment clips to wrap around any portion of the mobile device. Referring also to FIG. 4, the plurality of adhesives 204 are relatively flat and allows the mobile device stand 100 to be mounted in a flush fashion.

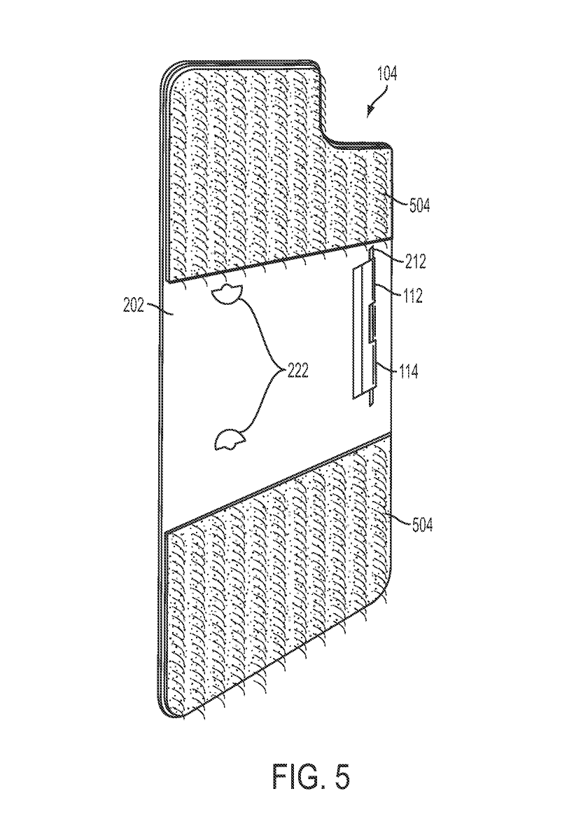

FIG. 5 illustrates a second embodiment of the attachment mechanism on the rear surface 202 for the mobile device stand 100. The attachment mechanism includes a plurality of hook and look-type fasteners 504, also marketed under the trademark VELCRO. The mobile device stand 100 may include the hook-type side or the loop-type side of the fastener, while the mobile device itself will have the matching portion of the fastener. Thus, by way of example and not limitation, if the rear surface 202 includes the hook-type side of the fastener, then the surface of the mobile device that attaches to the mobile device stand 100 will include the loop-type side of the fastener. The hook and loop-type fasteners may be attached to the mobile device stand 100 through the use of an adhesive. The hook and loop-type fasteners may also be attached to the mobile device in a similar fashion. As illustrated in the figure, the hook and loop-type fastener 504 may still be low profile and provide the ability for the user to remove the mobile device stand 100 when not in use. Further, another configuration of the mobile device stand 100 may be used, as long as it also includes a suitable portion of the hook and loop-type fastener.

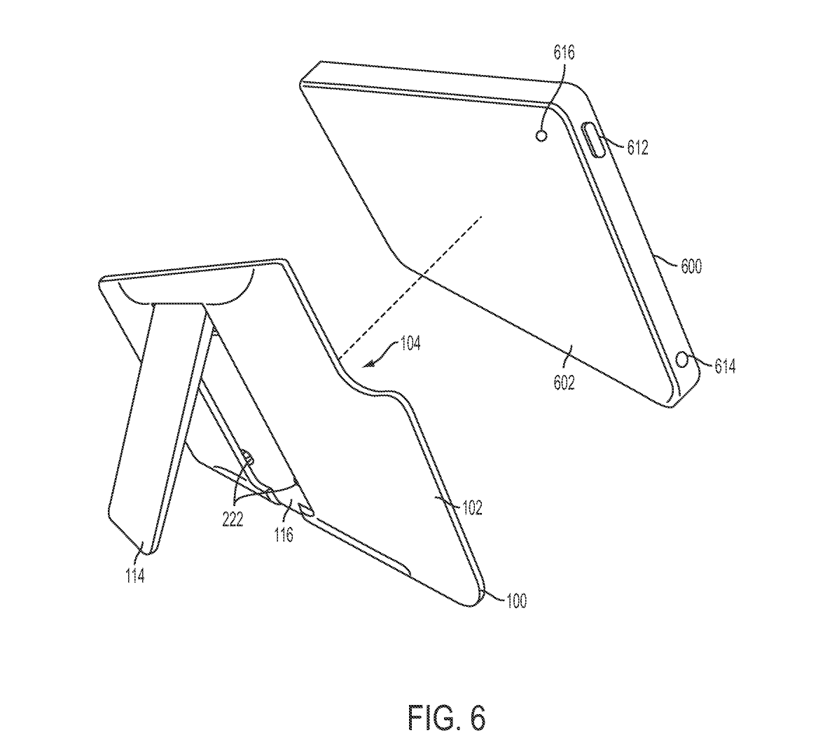

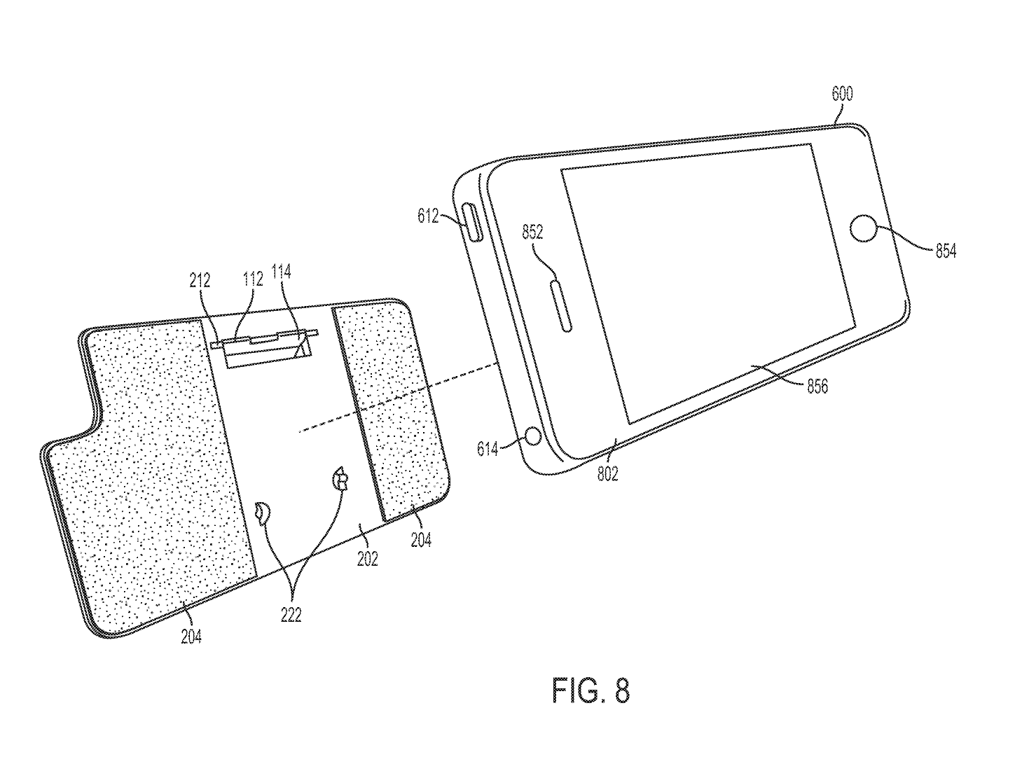

FIGS. 6-8 illustrate the mobile device stand 100 being mounted to a mobile device 600. In the example illustrated, the mobile device 600 is an iPhone-brand of smart phone as offered by Apple, Inc. The mobile device 600 includes a button 612, a jack 614, and a camera lens 616 on a rear surface 602. As illustrated in FIG. 8, the mobile device 600 also includes a front surface 802 that include a speaker 852, a button 854 and a screen 856. In one aspect of the present invention, the mobile device stand 100 is attached to the mobile device 600 by the plurality of adhesives 204 on the rear surface 202 to be attached to the rear surface 602 of the mobile device 600.

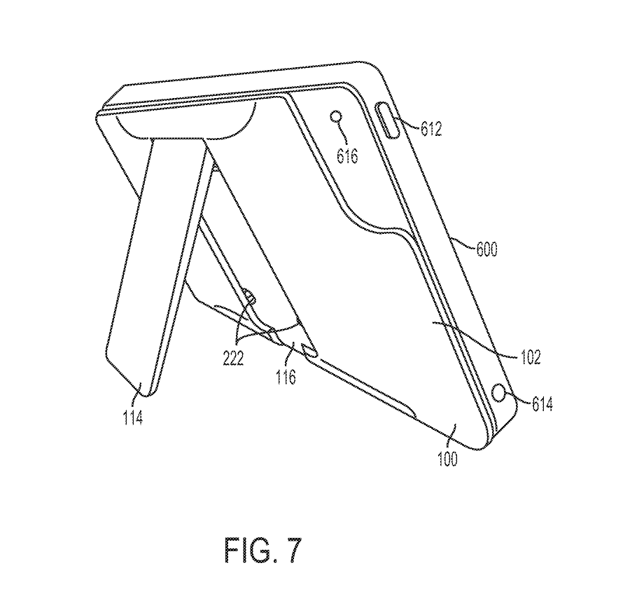

The mobile device stand 100 provides a low profile stand mechanism for the mobile device 600 that is low profile. Further, through the use of the attachment mechanisms described herein, the mobile device stand 100 is attached to the mobile device 600 without interfering with the features of the mobile device 600. Thus, even after the mobile device 600 is attached to the mobile device stand 100, as illustrated in FIG. 7, the camera lens 616 is still exposed through the notched portion 104. The mobile device stand 100 does not impair the operation of the button 612 nor the insertion of a plug into the jack 614 even while offering the ability for the screen 856 of the mobile device 600 to be propped-up by the stand 114 to achieve a comfortable viewing angle.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but is to be accorded the full scope consistent with the language claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A device stand, comprising:
a planar body comprising a first side and a second side, wherein the first side comprises:
a hinge; and
a stand coupled to the hinge to pivot around the hinge;
wherein the second side comprises a surface configured to conform to a mobile device; and
an adhesive layer coupled to the second side of the planar body.

2. The device stand of claim 1, further comprising a hook and loop-type fastener coupled to the adhesive layer.

3. The device stand of claim 2, further comprising a second hook and loop-type fastener coupled to the mobile device.

4. The device stand of claim 3, wherein the second hook and loop-type fastener is matched to the first hook and loop-type fastener.

5. The device stand of claim 3, wherein the second hook and loop-type fastener is coupled to the mobile device via a second adhesive layer.

6. The device stand of claim 1, wherein the first side further comprises a notched portion to receive the stand in a stored position.

7. A method for making a device stand comprising:
providing a planar body comprising a first side and a second side, wherein the first side comprises:
a hinge; and
a stand coupled to the hinge to pivot around the hinge;
wherein the second side comprises a surface configured to conform to a mobile device; and
attaching an adhesive layer to the second side of the planar body.

8. The method of claim 7, further comprising attaching a hook and loop-type fastener to the adhesive layer.

9. The method of claim 8, further comprising a second hook and loop-type fastener coupled to the mobile device.

10. The method of claim 9, wherein the second hook and loop-type fastener is matched to the first hook and loop-type fastener.

11. The method of claim 9, wherein the second hook and loop-type fastener is coupled to the mobile device via a second adhesive layer.

12. The method of claim 7, wherein the first side further comprises a notched portion to receive the stand in a stored position.

13. A device stand, comprising:
a planar body comprising a first side and a second side, wherein the first side comprises:
a hinge; and
a support means coupled to the hinge to pivot around the hinge;
wherein the second side comprises a surface configured to conform to a mobile device; and
an adhesive means coupled to the second side of the planar body.

14. The device stand of claim 1, further comprising a hook and loop-type fastener coupled to the adhesive means.

15. The device stand of claim 2, further comprising a second hook and loop-type fastener coupled to the mobile device.

16. The device stand of claim 3, wherein the second hook and loop-type fastener is matched to the first hook and loop-type fastener.

17. The device stand of claim 3, wherein the second hook and loop-type fastener is coupled to the mobile device via a second adhesive means.

18. The device stand of claim 1, wherein the first side further comprises a notched portion to receive the support means in a stored position.
